(19) United States
(12) Patent Application Publication
(10) Pub. No.: US 2012/0259887 A1
(43) Pub. Date: Oct. 11, 2012

(54) METHOD AND A SOFTWARE APPLICATION FOR THE SELECTION OF AN ANIMAL WITH DESIRABLE CHARACTERISTICS

(75) Inventor: Paul Andrew O'shea, Maryville (AU)

(73) Assignee: GLOBAL BLOODLINES PTY LTD, Maryville, New South Wales (AU)

(21) Appl. No.: 13/518,587

(22) PCT Filed: Dec. 23, 2010
(86) PCT No.: PCT/AU2010/001740

§ 371 Date: Jun. 22, 2012

Related U.S. Application Data
(60) Provisional application No. 61/377,624, filed on Aug. 27, 2010.

(30) Foreign Application Priority Data
Dec. 23, 2009 (AU) 2009906275

(51) Int. Cl. G06F 17/30

(52) U.S. Cl. 707/769; 707/E17.014

(57) ABSTRACT

A method for selecting an animal with desirable characteristics, including the steps of: receiving information regarding the parentage of the animal; arranging the parentage information into an appropriate structure; and utilizing an algorithm to identify a suitable animal based on the parentage of the animal. An apparatus and a program for practicing the method are also disclosed.

### FIELD OF THE INVENTION

The present invention relates to a method and a software application which assists in the selection of an animal with desirable characteristics, and also to the selection Of a suitable breeding pair of animals which would, when bred, have a high probability of producing offspring with desirable characteristics.

The invention has been developed primarily for use in the selection of horses (or horse breeding pairs) and will be described hereinafter with reference to this application. However, it will be appreciated that the invention is not limited to this particular field of use.

### BACKGROUND OF THE INVENTION

Horse racing has a very long and rich tradition.

Many countries have an established and successful horse racing industry, which contributes millions and in some cases billions of dollars to the local economy.

For many generations, horse breeders, stable owners, bookmakers and gamblers (“punters”) have devised, developed and refined a diverse range of methodologies for selecting a horse which is most likely to win a particular horse race.

The methodologies have been many and varied. Some have relied on measuring the known characteristics of the horse (e.g. size, speed, temperament, etc.). Other systems have relied on past performance (i.e. how the horse has performed in past races). Some systems have relied on superstition or “luck”.

Even methodologies that are founded on rational assumptions and known information (i.e. methodologies that rely on integrating known facts about horses and their behaviour) have produced mixed results. For example, it is known for breeders and owners to review and select the Phenotype and Genotype of breeding pairs with the goal of producing a better thoroughbred.

To this end, many mare owners/breeders send their mares to “dominant” stallions who are popular in the market, as they not only have a potency which provides a better class of thoroughbred (although results are never guaranteed), but in some instances, the mere art of mating a mare with a dominant stallion will “upgrade” the mare in the eyes of the market.

Using dominant stallions does produce better than average results, but the use of a dominant stallion commands a very large service fee. Breeders who cannot afford large service fees utilise less dominant stallions, again, with mediocre to average results. Studs and owner/breeders have themselves studied bloodlines over the years and utilized consultants who have experience in analysing pedigrees in an attempt to empower themselves to produce a quality thoroughbred. They mainly work on “nicks” and “crosses” that have been proven over years and/or follow breeding theories that have been documented by well respected authors.

However, all of these systems, theories and methodologies fail to work consistently.

### SUMMARY OF THE INVENTION

In a first aspect, the present invention provides a method for selecting an animal with desirable characteristics, comprising the steps of:

receiving information regarding the parentage of the animal;

arranging the parentage information into an appropriate structure; and

utilizing an algorithm to identify a suitable animal based on the parentage of the animal.

The appropriate structure may be a tree structure.

The algorithm may be varied dependent on the geographical location of the animal.

The algorithm may further comprise the step of firstly identifying selected animals in the appropriate structure. Each appropriate structure may be held within a database.

The animal may be a horse.

The algorithm may include the step of locating a common ancestor in the appropriate structure.

Where the animal is a horse, the common ancestor may be a Broodmare, or alternatively, the algorithm may include the, steps of identifying a grand-dam (2nd dam) that is by a sire whose grand-dam is the same broodmare as the dam of the Grand-sire, determining whether the grand-dam is mated with an identified Stallion, determining whether a filly foal eventuates from the mating of the grand-dam and the stallion, and if so, requires the mating the filly with the Sire of the Final Product Foal, wherein the Sire's Grand-dam is the same Broodmare as the Final Product Foal's Broodmare Sire's dam's Sire's dam.

In an embodiment, the method for selecting an animal with desirable characteristics is implemented by a processor. The method may be implemented by a computing system.

In accordance with a second aspect, the invention provides an apparatus for selecting an animal with desirable characteristics, comprising a processor and memory, arranged to receive information regarding the parentage of the animal, arranged to arrange the parentage information into an appropriate structure within the memory, and arranged to implement an algorithm to identify a suitable animal based on the parentage of the animal.

In a third aspect, the invention provides a computing program, arranged to, when executed on a computing system, perform the method steps in accordance with the first aspect of the invention.

In a fourth aspect, the invention provides a computer readable medium incorporating a computer program in accordance with the second aspect of the invention.

### DETAILED DESCRIPTION OF THE DRAWINGS

Notwithstanding any other embodiments that may fall within the scope of the present invention, an embodiment of the present invention will now be described, by way of example only, with reference to the accompanying figures, in which:

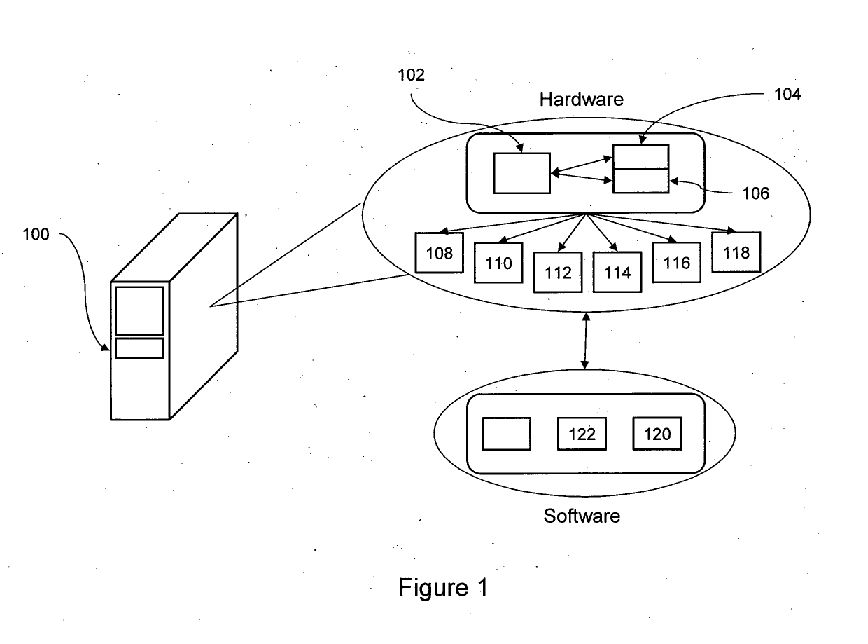

FIG. 1 is a computing system that may be utilized to perform a selection in accordance with an embodiment of the present invention;

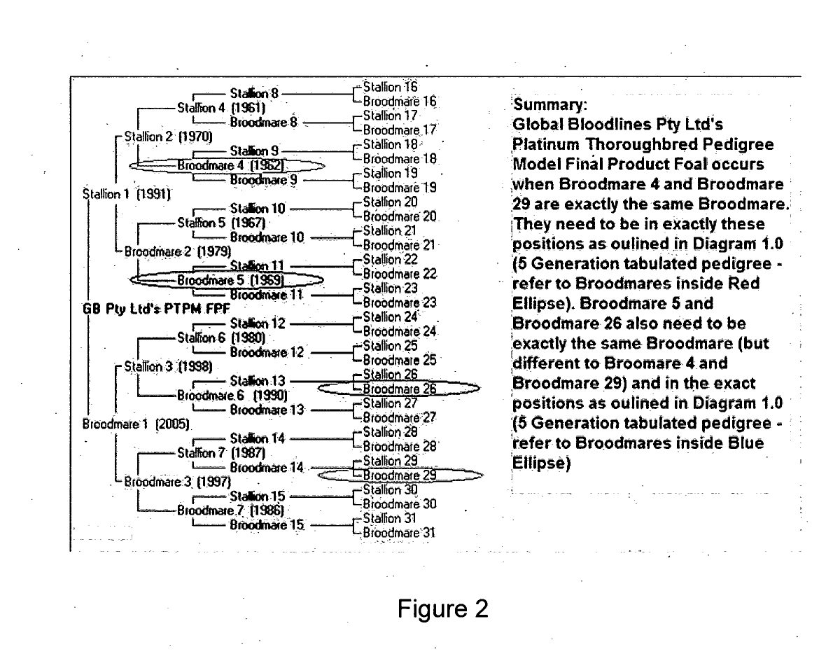

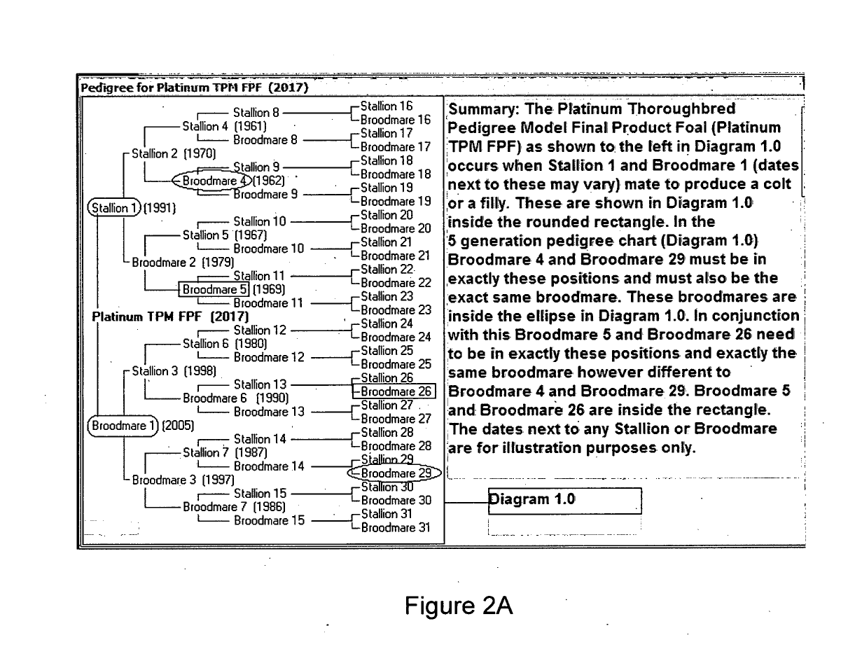

FIGS. 2 and 2A are diagrams displaying successive generations of horses and the relevant characteristics desired when selecting a breeding pair, in accordance with the application of an embodiment of the present invention;

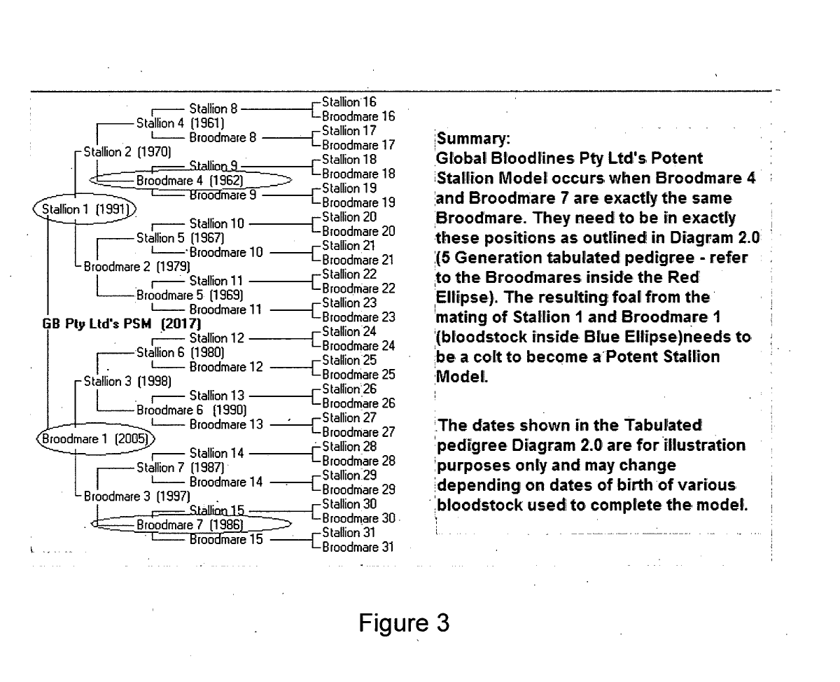

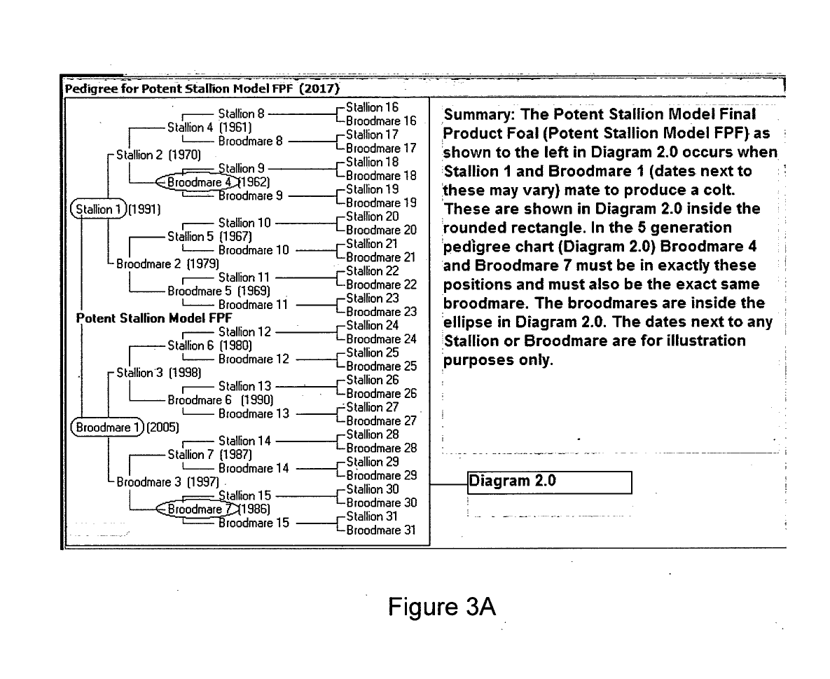

FIGS. 3 and 3A are diagrams illustrating successive generations of horses and relevant characteristics desired when selecting a breeding pair, in accordance with another embodiment of the present invention; and

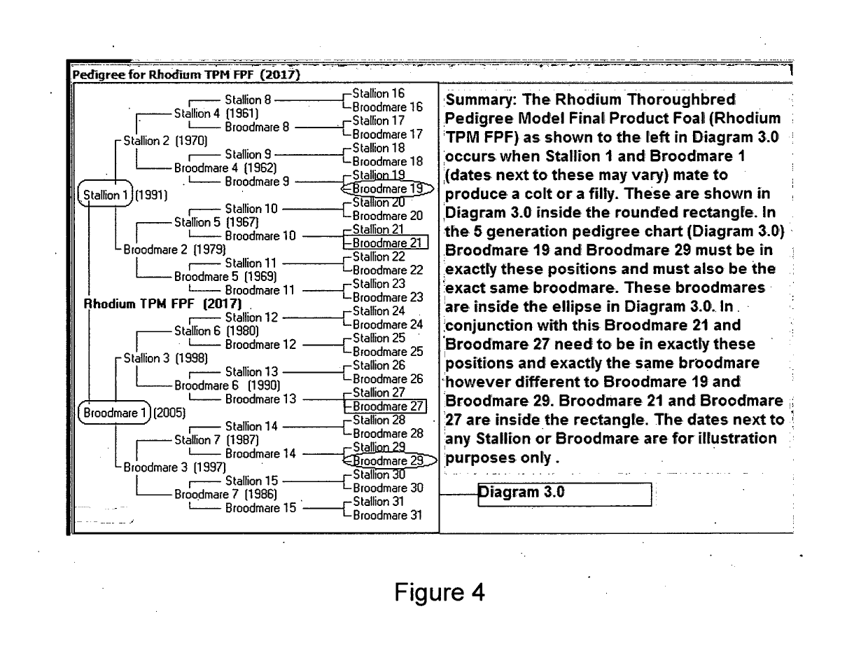

FIGS. 4 to 21 are diagrams illustrating different models that describe successive generations of horses and relevant characteristics desired when selecting a breeding pair, in accordance with different embodiments of the invention.

### DESCRIPTION OF PREFERRED/SPECIFIC EMBODIMENTS

### Overview

It will be understood that an embodiment of the present invention may be implemented on a computing system, such as the system described with reference to FIG. 1.

At FIG. 1 there is shown a schematic diagram of a computing system 100 suitable for use with an embodiment of the present invention. The computing system 100 may be used to execute applications and/or system services such as a rental property management system in accordance with an embodiment of the present invention. The computing system 100 preferably comprises a processor 102, read only memory (ROM) 104, random access memory (RAM) 106, and input/output devices such as disk drives 108, keyboard 110, mouse 112, display 114, printer 116, and communications link 118. The computer includes programs that may be stored in RAM 106, ROM 104, or disk drives 108 and may be executed by the processor 102. The communications link 118 connects to a computer network such as the Internet but may be connected to a telephone line, an antenna, a gateway or any other type of communications link. Disk drives 108 may include any suitable storage media, such as, for example, floppy disk drives, hard disk drives, CD ROM drives or magnetic tape drives. The computing system 100 may use a single disk drive 108 or multiple disk drives. The computing system 100 may use any suitable operating systems, such as Windows™ or Unix™.

It will be understood that the computing system described in the preceding paragraphs is illustrative only, and that an embodiment of the present invention may be executed on any suitable computing system, with any suitable combination of hardware and/or software.

In one embodiment, the present invention is implemented as a software application 120 which interacts with a database 122, arranged to be executable on the computing system 100.

### Specific Embodiment

The embodiment described herein utilises a large data set of race results and historical breeding patterns of thoroughbred horses over numerous decades in order to identify the strongest “patterns” which may then be presented as a model that allows breeders, owners and other interested parties to identify the best race horses (and/or identify breeding pairs which may be bred to produce the best race horses).

In the context of the embodiment, it will be understood that the term “best” is a generic term that refers to a desired set of characteristics. For example, - in the context of the example given below, the “best” horse is the horse that has the highest probability of winning a particular type of horse race. That is, the desirable characteristics of the horse (such as running speed, stamina, temperament, etc.) are such that it has a high probability of winning the desired race.

In other examples, it will be understood that “best” may be utilised to refer to other desired characteristics, ranging from physical traits, to behavioural traits.

The model is created by firstly reviewing multiple generations of horses (and their progeny) so as to identify patterns. These patterns, once identified, can be abstracted or generalised in order to create an algorithm, which may then be applied to any generational chart.

In the embodiment described herein, which may relate to horses both in Australia and internationally, there is provided an example created by Global Bloodlines Pty Ltd (an Australian company which is also the applicant of this application). The example is termed the “Platinum Thoroughbred Pedigree Model Final Product Foal”™. It is a methodology which is derived by applying the set of rules (i.e. an algorithm) to a particular Australian bloodline. For the purpose of this example, particular horses are not identified, as the model relies on predefined patterns which apply irrespective of the specific horses in a family tree.

Referring to FIGS. 2 and 2A, there is shown a Generic Model which lists a series of generations of horses, and the bloodlines (or blood ties) between each horse. It has been found that by applying the following algorithm, a suitable breeding pair (or suitable horse) may be identified:
1. The grand-dam (2^{nd} nd dam) (Broodmare 3 in the generic model) of the final product foal can be from any family in the studbook but firstly needs to be by a sire (Stallion 7 in the generic model) whose grand-dam (2^{nd} dam) (Broodmare 29 in the generic model) is exactly the same broodmare as the dam (1^{st} dam) (Broodmare 4 in the generic model) of the Grand-sire (Stallion 2 in the generic model) of the Final Product Foal.
2. This grand-dam. (2^{nd} dam) (Broodmare 3 in the generic model) in step 1 needs to be mated first of all with a Stallion (Stallion 3 in the generic model) that meets the specific criteria outlined in step 3 as well as in Diagram 1.0. The resulting foal must be a filly for the model to be able to progress to the next step (some mares with this formula do already exist in the current market but are very rare).
3. If a filly foal eventuates from step 2 then this filly (or mare once mature) needs to be mated with the Sire of the Final Product Foal (Stallion 1 in the generic model). This Sire's (Stallion 1 in the generic model) Grand-dam (2^{nd} dam) (Broodmare 5 in the generic model) needs to be exactly the same Broodmare as the Final Product Foal's Broodmare Sire's (Stallion 3 in the generic model as mentioned in step 2) dam's (Broodmare 6 in the generic model) Sire's (Stallion 13 in the generic model) dam (Broodmare 26 in the generic model).
4. This resulting foal from Step 3 (either a filly or colt) is the Final Product Foal of the Model (i.e. the desired animal).

The index included at Appendix A has been supplied to elaborate further on the details of the Generic Model used above.

In an alternative embodiment, as shown with reference to FIGS. 3 and 3A, a potent stallion model occurs where Broodmare 4 (highlighted in FIG. 3) is the same horse as Broodmare 7 (also highlighted in FIG. 3). Where the same Broodmare is present in the positions shown in FIGS. 3 and 3A, and the resulting Foal from the mating of Stallion 1 and Broodmare 1 is a colt, then the Potent Stallion Model is achieved.

It should be noted that the dates displayed as “Dates of Birth for Thoroughbreds” in the model are used for display purposes only. Once the fourth and fifth generations are reached, no Dates of Birth are able to be displayed in the model. When applied to a “real world”example, these Dates of Birth may vary depending on the chosen sires and dams utilized that meet the model criteria.

The algorithm supplied above is codified into a software application such that a user of the application can create, download, or otherwise supply a suitable family tree and apply the algorithm to identify a desired horse or a desired breeding pair. The algorithm (steps 1 to 4 can be re-applied for each family tree (or juxtaposition of family trees).

As such, in one embodiment, the software application further includes a database arranged to hold a plurality of family trees, such that relevant family trees may be “mixed and matched” as required by the user.

Below, there are described a series of different models, which operate in the same manner as the Generic Model and the alternative model described above.

The difference between each model lies in the “qualities” of the progeny produced/predicted by each model. To put it another way, each model offers a different probability of providing a progeny with particular characteristics, dependent on the breeding pair selected by the model. The reason for providing different models is to allow the user to choose a model that best suits the required traits defined by the user.

For example, some models may be optimised to produce a progeny that is the best “all rounder”. Another model may be optimised to produce a progeny with the fastest running speed, or the best temperament, or the best performance in wet conditions, or the best stamina, etc. In other words, models may be provided to optimise for particular characteristics.

In the examples given below, each model is shown, for illustrative purposes only, to highlight the broader concept described above. Each model is optimised for a different characteristic.

### Rhodium Embodiment

In the embodiment described herein, which may relate to horses both in Australia and Internationally, there is provided an example created by Global Bloodlines Pty Ltd (an Australian company which is also the applicant of this application) The example termed the “Rhodium Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 4, there is shown a Generic Model which lists a series of generations of horses. (5 Generation pedigree chart), and the bloodlines (or blood ties) between each horse. It has been found that by applying the following algorithm, a suitable breeding pair (or suitable horse) may be identified:
1. The grand-dam (2^{nd} dam) (Broodmare 3 in the generic model) of the final product foal can be from any family in the studbook but firstly needs to be by a sire (Stallion 7 in the generic model) whose grand-dam (2^{st} dam) (Broodmare 29 in the generic model) is exactly the same broodmare as the great grand-dam (3^{rd} dam) (Broodmare 19 in the generic model of the Grand-sire (Stallion 2 in the generic model) of the Final Product Foal.
2. This grand-dam (2^{nd} dam) (Broodmare 3 in the generic model) in step 1 needs to be mated first of all with a Stallion (Stallion 3 in the generic model) that meets the specific criteria outlined in step 3 as well as Diagram 3.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) broodmare sire's (Stallion 5 in the generic model) grand-dam (Broodmare 21 in the generic model) needs to be exactly the same broodmare as the Final Product Foal's Broodmare Sire's (Stallion 3 in the generic model) great grand-dam (3^{rd} dam) (Broodmare 27 in the generic model).
4. The resulting foal from step 3 (either a filly or colt) is the Final Product Foal of the Rhodium Thoroughbred Pedigree Model (i.e. the desired animal).

### Gold Embodiment

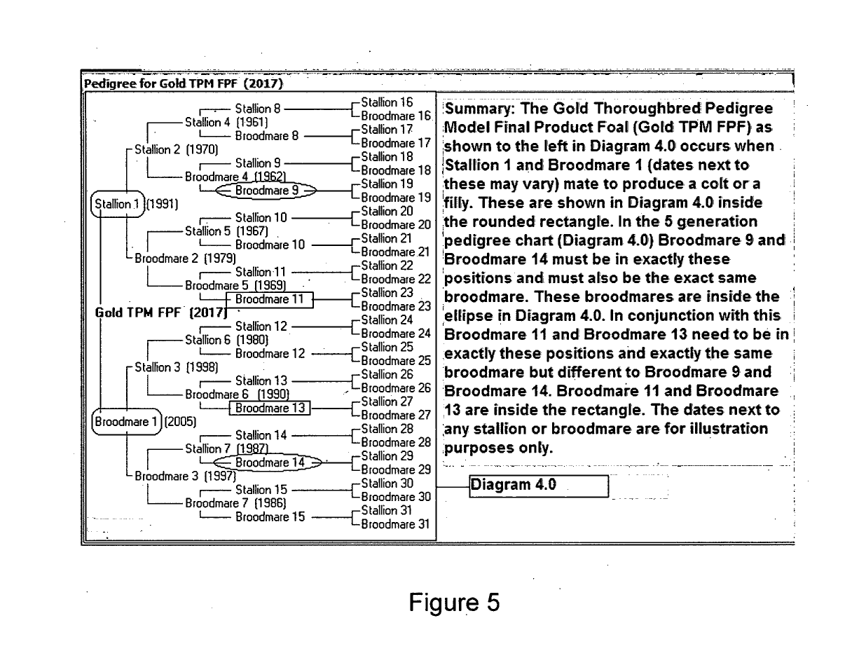

In the embodiment described herein, which may relate to horses both in Australia and Internationally, there is provided an example created by Global Bloodlines Pty Ltd (an Australian company which is also the applicant of this application) The example termed the “Gold Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 5, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The grand-dam (2^{nd} dam) (Broodmare 3 in the generic model) of the final product foal can be from any family in the studbook but firstly needs to be by a sire (Stallion 7 in the generic model) whose dam (1^{st} dam) (Broodmare 14 in the generic model) is exactly the same broodmare as the grand-dam (2^{nd} dam) (Broodmare 9 in the generic model) of the Grand-sire (Stallion 2 in the generic model) of the Final Product Foal.
2. This grand-dam (2^{nd} dam) (Broodmare 3 in the generic model) in step 1 needs to be mated first of all with a Stallion (Stallion 3 in the generic model) that meets the specific criteria outlined in step 3 as well as Diagram 4.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) great grand-dam (3^{rd} dam) (Broodmare 11 in the generic model) needs to be exactly the same broodmare as the Final Product Foal's Broodmare Sire's (Stallion 3 in the generic model) grand-dam (2^{nd} dam) (Broodmare 13 in the generic model)
4. The resulting foal from step 3 (either a filly or colt) is the Final Product Foal of the Gold Thoroughbred Pedigree Model (i.e. the desired animal).

### Iridium Embodiment

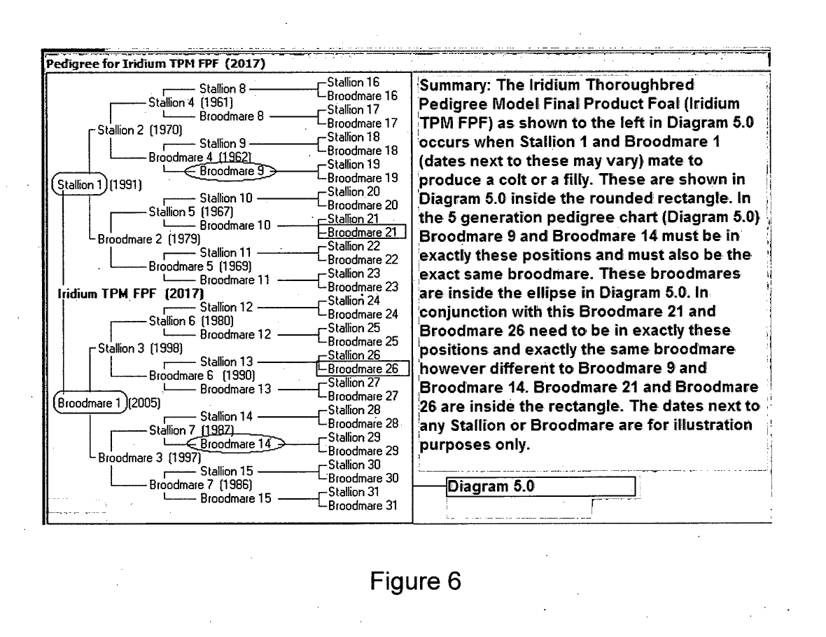

In the embodiment described herein, which may relate to horses both in Australia and Internationally, there is provided an example treated by Global Bloodlines Pty Ltd (an Australian company which is also the applicant of this application) The example termed the “Iridium Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 6, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The grand-dam (2^{nd} dam) (Broodmare 3 in the generic model) of the final product foal can be from any family in the studbook but firstly needs to be by a sire (Stallion 7 in the generic model) whose dam (1^{st} dam) (Broodmare 14 in the generic model) is exactly the same broodmare as the grand-dam (2^{nd} dam) (Broodmare 9 in the generic model) of the Grand-sire (Stallion 2 in the generic model) of the Final Product Foal.
2. This grand-dam (2ⁿ dam) (Broodmare 3 in the generic model) in step 1 needs to be mated first of all with a Stallion (Stallion 3 in the generic model) that meets the specific criteria outlined in step 3 as well as Diagram 5.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) broodmare sire's (Stallion 5 in the generic model) grand-dam (Broodmare 21 in the generic model) needs to be exactly the same broodmare as the Final Product Foal's Broodmare Sire's (Stallion 3 in the generic model) dam's Sire's dam (Broodmare 26 in the generic model)
4. The resulting foal from step 3 (either a filly or colt) is the Final Product Foal of the Iridium Thoroughbred Pedigree Model (i.e. the desired animal).

### Osmium Embodiment

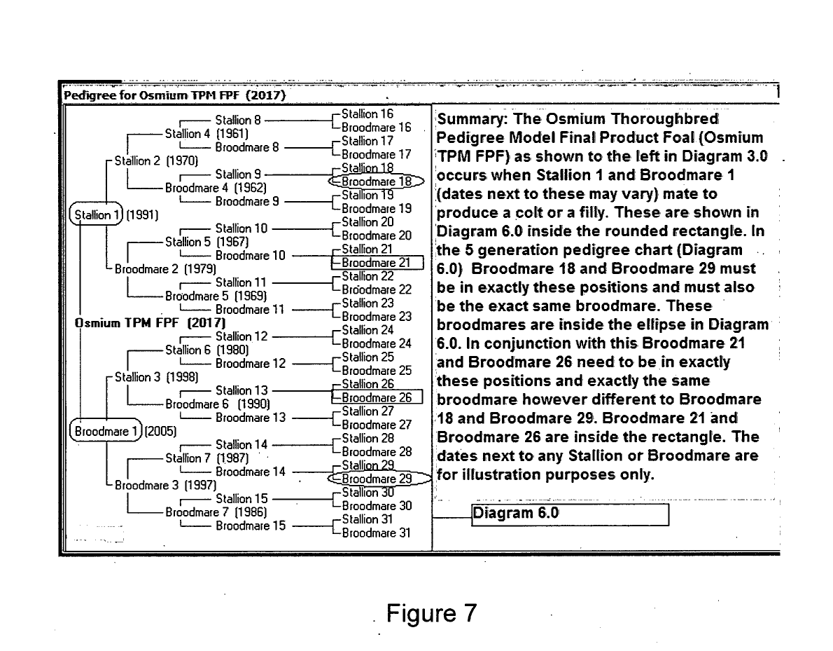

In the embodiment described herein, which may relate to horses both in Australia and Internationally, there is provided an example created by Global Bloodlines Pty Ltd (an Australian company which is also the applicant of this application) The example termed the “Osmium Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 7, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The grand-dam (2^{d} dam) (Broodmare 3 in the generic model) of the final product foal can be from any family in the studbook but firstly needs to be by a sire (Stallion 7 in the generic model) whose grand-dam (2^{nd} dam) (Broodmare 29 in the generic model) is exactly the same broodmare as the grand-sire's (Stallion 2 in the generic model) broodmare sire's (Stallion 9 in the generic model) dam (Broodmare 18 in the generic model) of the Final Product Foal.
2. This grand-dam (2^{nd} dam) (Broodmare 3 in the generic model) in step 1 needs to be mated first of all with a Stallion (Stallion 3 in the generic model) that meets the specific criteria outlined in step 3 as well as Diagram 6.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) broodmare sire's (Stallion 5 in the generic model) grand-dam (Broodmare 21 in the generic model) needs to be exactly the same broodmare as the Final Product Foal's Broodmare Sire's (Stallion 3 in the generic model) dam's Sire's dam (Broodmare 26 in the generic model)
4. The resulting foal from step 3 (either a filly or colt) is the Final Product Foal of the Osmium Thoroughbred Pedigree Model (i.e. the desired animal).

### Palladium Embodiment

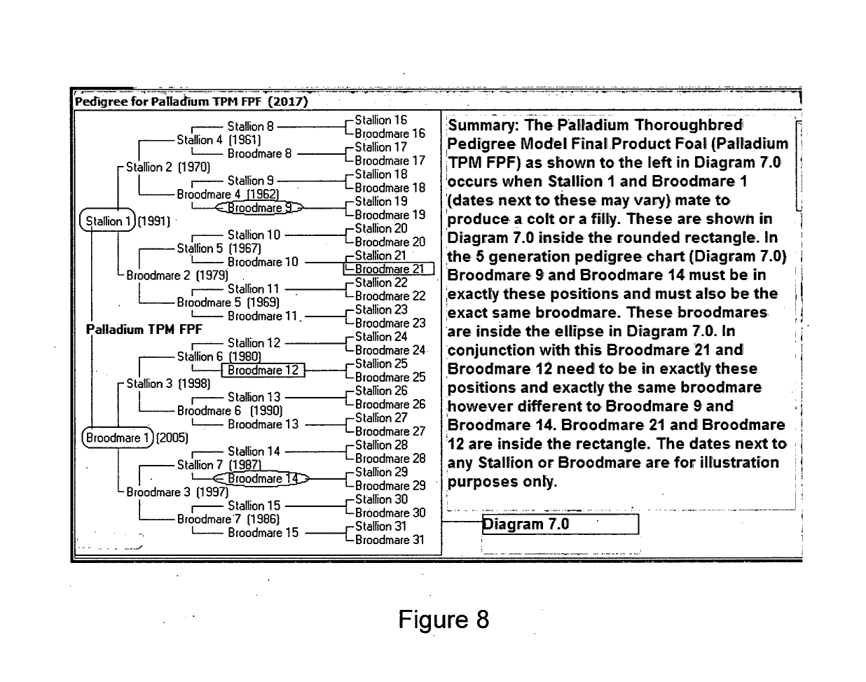

In the embodiment described herein, which may relate to horses both in Australia and Internationally, there is provided an example created by Global Bloodlines Pty Ltd (an Australian company which is also the applicant of this application) The example termed the “Palladium Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 8, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The grand-dam (2^{nd} dam) (Broodmare 3 in the generic model) of the final product foal can be from any family in the studbook but firstly needs to be by a sire (Stallion 7 in the generic model) whose dam (1^{st} dam) (Broodmare 14 in the generic model) is exactly the same broodmare as the grand-dam (2^{nd} dam) (Broodmare 9 in the generic model) of the Grand-sire (Stallion 2 in the generic model) of the Final Product Foal.
2. This grand-dam (2^{nd} dam) (Broodmare 3 in the generic model) in step 1 needs to be mated first of all with a Stallion (Stallion 3 in the generic model) that meets the specific criteria outlined in step 3 as well as Diagram 7.0. The resulting foal mist be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) broodmare sire's (Stallion 5 in the generic model) grand-dam (Broodmare 21 in the generic model) needs to be exactly the same broodmare as the Final Product Foal's Broodmare Sire's (Stallion 3 in the generic model) Sire's dam (Broodmare 12 in the generic model)
4. The resulting foal from step 3 (either a filly or colt) is the Final Product Foal of the Palladium Thoroughbred Pedigree Model (i.e. the desired animal).

### Rhenium Embodiment

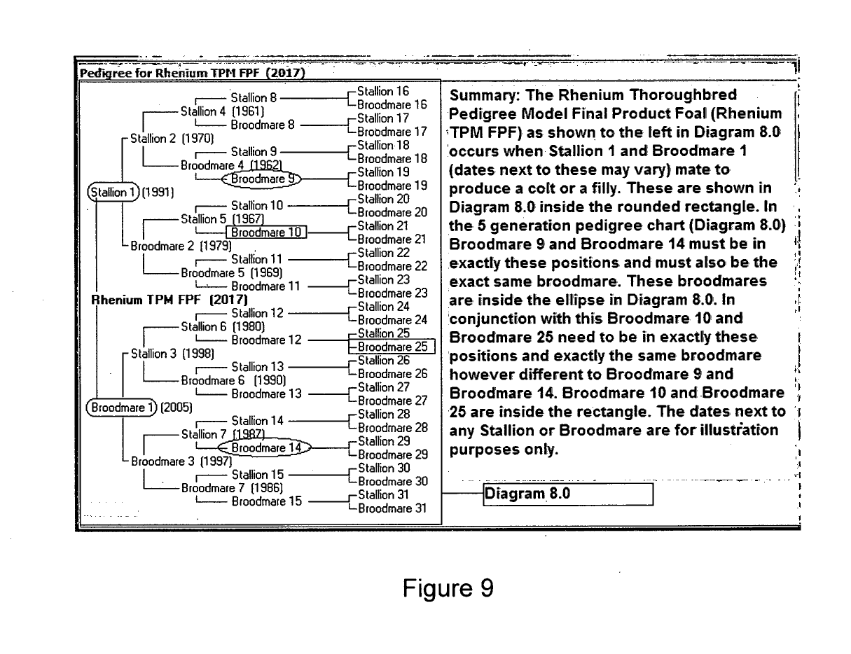

In the embodiment described herein, which may relate to horses both in Australia and Internationally, there is provided an example created by Global Bloodlines Pty Ltd (an Australian company which is also the applicant of this application) The example termed the “Rhenium Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 9, there is shown a Generic Model which lists a series of generations of horses (5 Generation pedigree chart), and the bloodlines (or blood ties) between each horse. It has been found that by applying the following algorithm, a suitable breeding pair (or suitable horse may be identified:
1. The grand-dam (2^{nd} dam) (Broodmare 3 in the generic model) of the final product foal can be from any family in the studbook but firstly needs to be by a sire (Stallion 7 in the generic model) whose dam (1^{st} dam) (Broodmare 14 in the generic model) is exactly the same broodmare as the grand-dam (2^{nd} dam) (Broodmare 9 in the generic model) of the Grand-sire (Stallion 2 in the generic model) of the Final Product Foal.
2. This grand-dam (2^{nd} dam) (Broodmare 3 in the generic model) in step 1 needs to be mated first of all with a Stallion (Stallion 3 in the generic model) that meets the specific criteria outlined in step 3 as well as Diagram 8.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) broodmare sire's (Stallion 5 in the generic model) dam (Broodmare 10 in the generic model) needs to be exactly the same broodmare as the Final Product Foal's Broodmare Sire's (Stallion 3 in the generic model) Sire's grand-dam (Broodmare 25 in the generic model)
4. The resulting foal from step 3 (either a filly or colt) is the Final Product Foal of the Rhenium Thoroughbred Pedigree Model (i.e. the desired animal).

### Ruthenium Embodiment

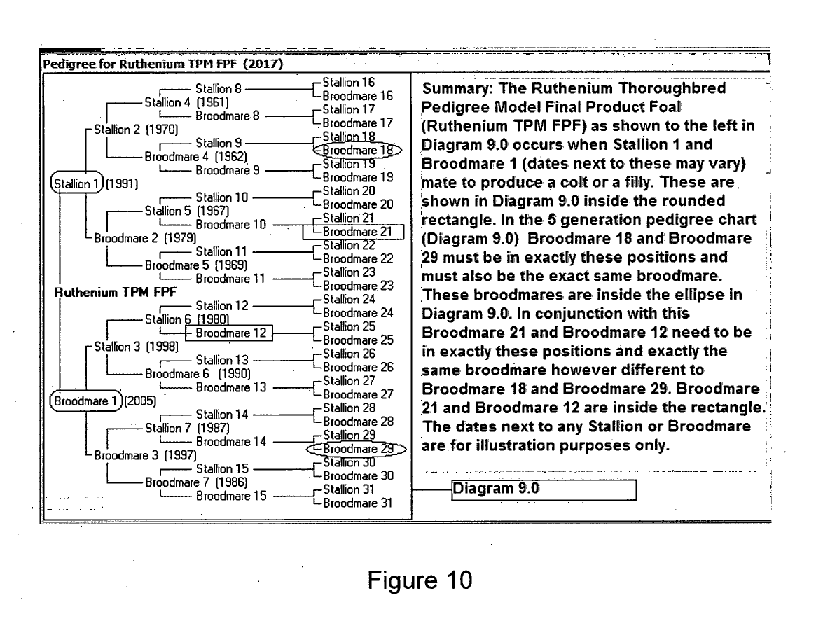

In the embodiment described herein, which may relate to horses both in Australia and Internationally, there is provided an example created by Global Bloodlines Pty Ltd (an Australian company which is also the applicant of this application) The example termed the “Ruthenium Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 10, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The grand-dam (2^{nd} dam) (Broodmare 3 in the generic model) of the final product foal can be from any family in the studbook but firstly needs to be by a sire (Stallion 7 in the generic model) whose grand-dam (2^{nd} dam) (Broodmare 29 in the generic model) is exactly the same broodmare as the Grand-sire's (Stallion 2 in the generic model) broodmare sire's dam (Broodmare 18 in the generic model) of the Final Product Foal.
2. This grand-dam (2^{nd} dam) (Broodmare 3 in the generic model) in step 1 needs to be mated first of all with a Stallion (Stallion 3 in the generic model) that meets the specific criteria outlined in step 3 as well as Diagram 9.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) broodmare sire's (Stallion 5 in the generic model) grand-dam (Broodmare 21 in the generic model) needs to be exactly the same broodmare as the Final Product Foal's Broodmare Sire's (Stallion 3 in the generic model) Sire's dam (Broodmare 12 in the genetic model)
4. The resulting foal from step 3 (either a filly or colt) is the Final Product Foal of the Ruthenium Thoroughbred Pedigree Model (i.e. the desired animal).

### Germanium Embodiment

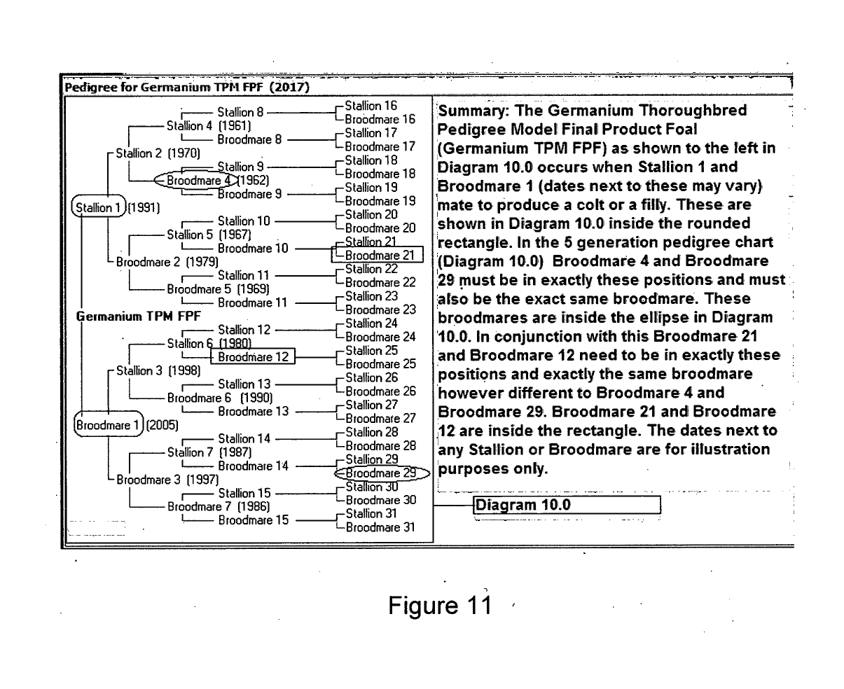

In the embodiment described herein, which may relate to horses both in Australia and Internationally, there is provided an example created by Global Bloodlines Pty Ltd (an Australian company which is also the applicant of this application) The example termed the “Germanium Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 11, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The grand-dam (2ⁿd dam) (Broodmare 3 in the generic model) of the final product foal can be from any family in the studbook but firstly needs to be by a sire (Stallion 7 in the generic model) whose grand-dam (2^{nd} dam) (Broodmare 29 in the generic model) is exactly the same broodmare as the dam (Broodmare 4 in the generic model) of the Grand-sire (Stallion 2 in the generic model) of the Final Product Foal.
2. This grand-dam (2^{nd} dam) (Broodmare 3 in the generic model) in step 1 needs to be mated first of all with a Stallion (Stallion 3 in the generic model) that meets the specific criteria outlined in step 3 as well as Diagram 10.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) broodmare sire's (Stallion 5 in the generic model) grand-dam (Broodmare 21 in the generic model) needs to be exactly the same broodmare as the Final Product Foal's Broodmare Sire's (Stallion 3 in the generic model) Sire's dam (Broodmare 12 in the generic model)
4. The resulting foal from step 3 (either a filly or colt) is the Final Product Foal of the Germanium Thoroughbred Pedigree Model (i.e. the desired animal).

### Beryllium Embodiment

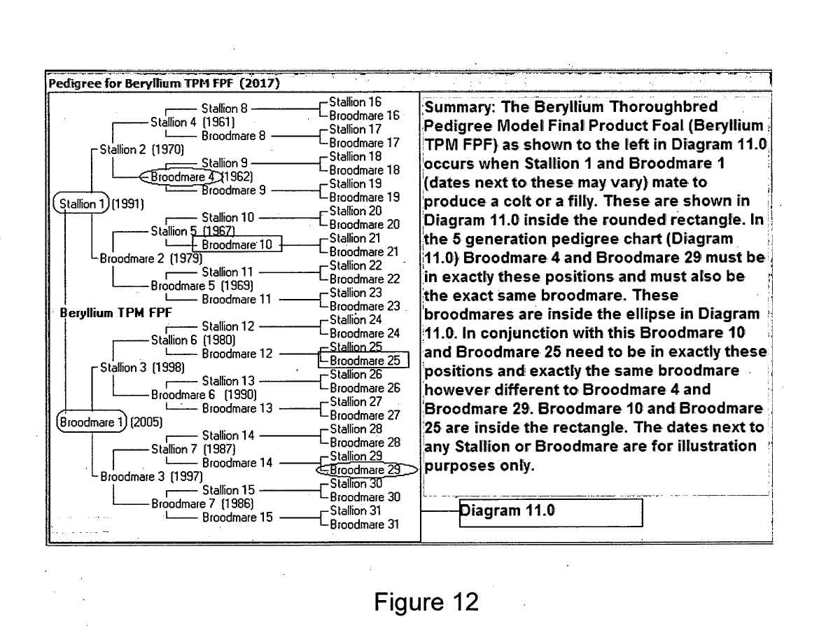

In the embodiment described herein, which may relate to horses both in Australia and Internationally, there is provided an example created by Global Bloodlines Pty Ltd (an Australian company which is also the applicant of this application) The example termed the “Beryllium Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 12, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The grand-dam (2^{nd} dam) (Broodmare 3 in the generic model) of the final product foal can be from any family in the studbook but firstly needs to be by a sire (Stallion 7 in the generic model) whose grand-dam (2^{nd} dam) (Broodmare 29 in the generic model) is exactly the same broodmare as the dam (Broodmare 4 in the generic model) of the Grand-sire (Stallion 2 in the generic model) of the Final Product Foal.
2. This grand-dam (2^{nd} dam) (Broodmare 3 in the generic model) in step 1 needs to be mated first of all with a Stallion (Stallion 3 in the generic model) that meets the specific criteria outlined in step 3 as well as Diagram 11.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) broodmare sire's (Stallion 5 in the generic model) dam (Broodmare 10 in the generic model) needs to be exactly the same broodmare as the Final Product Foal's Broodmare Sire's (Stallion 3 in the generic model) Sire's grand-dam (Broodmare 25 in the generic model)
4. The resulting foal from step 3 (either a filly or colt) is the Final Product Foal of the Beryllium Thoroughbred Pedigree Model (i.e. the desired animal).

### Silver Embodiment

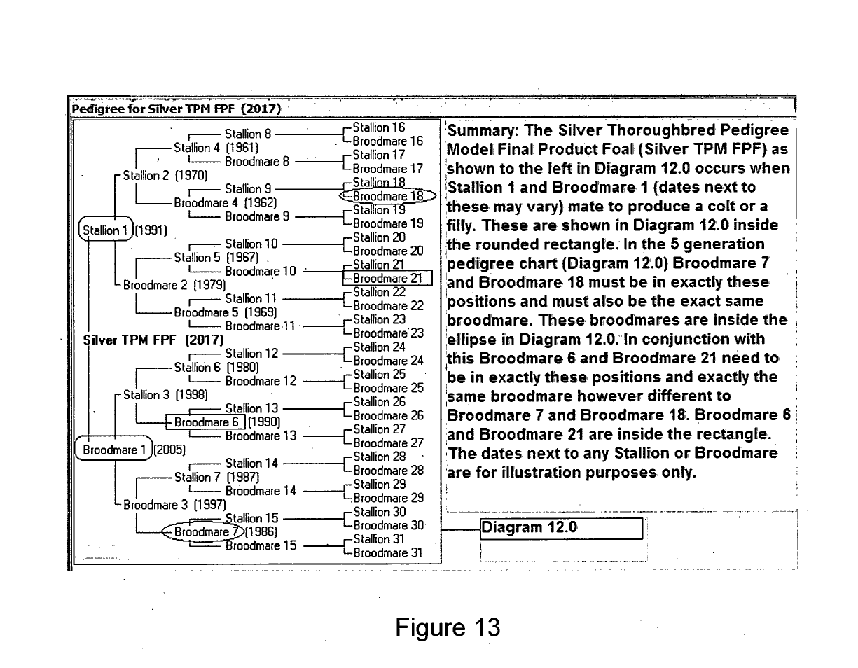

In the embodiment described herein, which may relate to horses both in Australia and Internationally, there is provided an example created by Global Bloodlines Pty Ltd (an Australian company which is also the applicant of this application) The example termed the “Silver Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 13, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The grand-dam (2^{nd} dam) (Broodmare 3 in the generic model) of the final product foal can be from any family in the studbook but firstly needs to be out of a dam (Broodmare 7) that is exactly the same broodmare as the Grand-sire's (Stallion 2 in the generic model) broodmare sire's dam (Broodmare 18 in the generic model) of the Final Product Foal.
2. This grand-dam (2^{nd} dam) (Broodmare 3 in the generic model) in step needs to be mated first of all with a Stallion (Stallion 3 in the generic model) that meets the specific criteria outlined in step 3 as well as Diagram 12.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) broodmare sire's (Stallion 5 in the generic model) grand-dam (Broodmare 21 in the generic model) needs to be exactly the same broodmare as the Final Product Foal's Broodmare Sire's (Stallion 3 in the generic model) dam (Broodmare 6 in the generic model)
4. The resulting foal from step 3 (either a filly or colt) is the Final Product Foal of the Silver Thoroughbred Pedigree Model (i.e. the desired animal).

### Gallium Embodiment

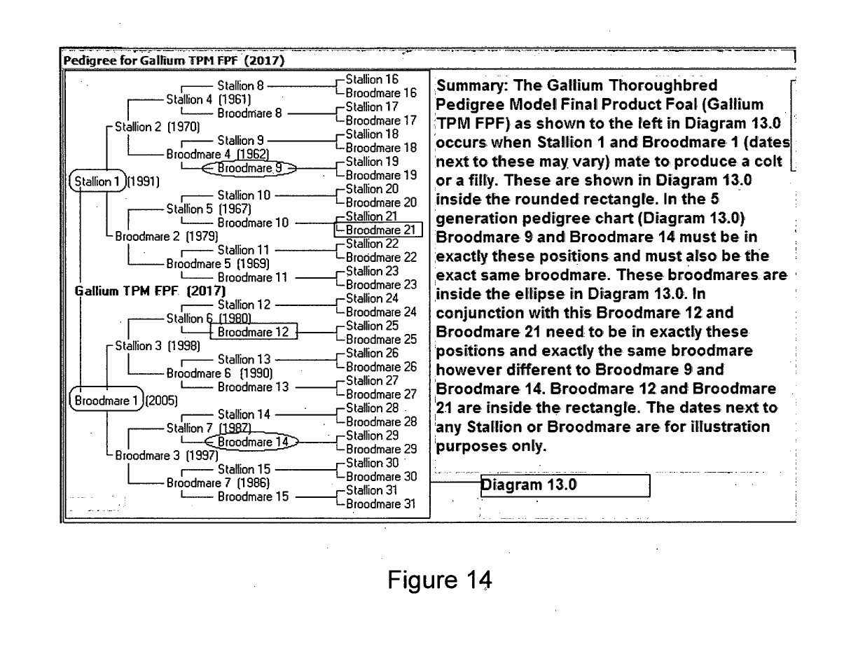

In the embodiment described herein, which may relate to horses both in Australia and Internationally, there is provided an example created by Global Bloodlines Pty Ltd (an Australian company which is also the applicant of this application) The example termed the “Gallium Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 14, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The grand-dam (2^{nd} dam) (Broodmare 3 in the generic model) of the final product foal can be from any family in the studbook but firstly needs to be by a sire (Stallion 7 in the generic model) whose dam (Broodmare 14 in the generic model) is exactly the same broodmare as the grand-dam (2^{nd} dam) (Broodmare 9 in the generic model) of the Grand-sire (Stallion 2 in the generic model) of the Final Product Foal.
2. This grand-dam (2^{nd} dam) (Broodmare 3 in the generic model) in step 1 needs to be mated first of all with a Stallion (Stallion 3 in the generic model) that meets the specific criteria outlined in step 3 as well as Diagram 13.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) broodmare sire's (Stallion 5 in the generic model) grand-dam (Broodmare 21 in the generic model) needs. to be exactly the same broodmare as the Final Product Foal's Broodmare Sire's (Stallion 3 in the generic model) Sire's dam (Broodmare 12 in the generic model)
4. The resulting foal from step 3 (either a filly or colt) is the Final Product Foal of the Gallium Thoroughbred Pedigree Model (i.e. the desired animal).

### Indium Embodiment

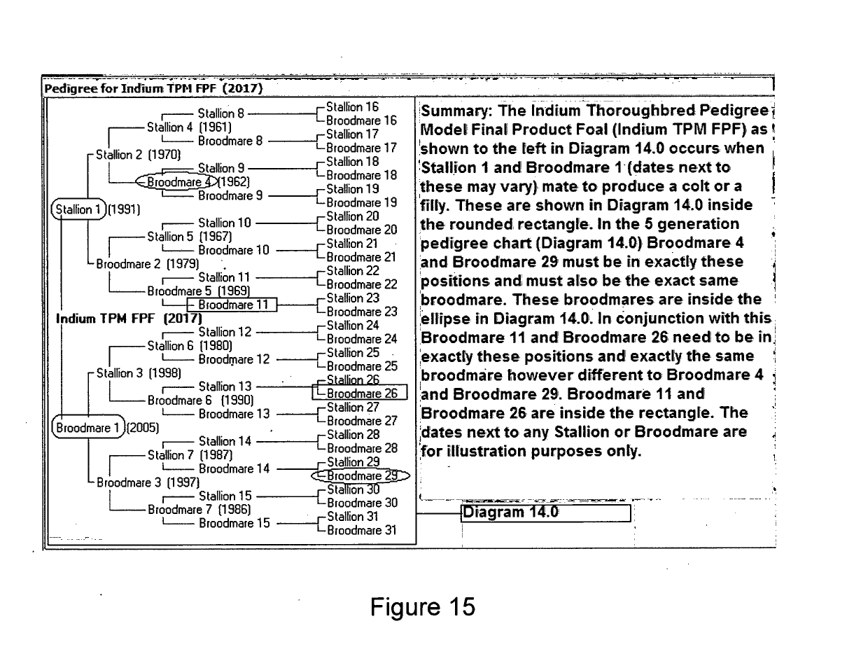

In the embodiment described herein, which may relate to horses both in Australia and Internationally, there is provided an example created by Global Bloodlines Pty Ltd (an Australian company which is also the applicant of this application) The example termed the “Indium Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 15, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The grand-dam (2^{nd} dam) (Broodmare 3 in the generic model) of the final product foal can be from any family in the studbook but firstly needs to be by a sire (Stallion 7 in the generic model) whose grand-dam (Broodmare 29 in the generic model) is exactly the same broodmare as the dam (Broodmare 4 in the generic model) of the Grand-sire (Stallion 2 in the generic model) of the Final Product Foal.
2. This grand-dam (2^{nd} dam) (Broodmare 3 in the generic model) in step 1 needs to be mated first of all with a Stallion (Stallion 3 in the generic model) that meets the specific criteria outlined in step 3 as well as Diagram 14.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) great grand-dam (3^{rd} dam) (Broodmare 11 in the generic model) needs to be exactly the same broodmare as the Final Product Foal's Broodmare Sire's (Stallion 3 in the generic model) dam's Sire's dam (Broodmare 26 in the generic model)
4. The resulting foal from step 3 (either a filly or colt) is the Final Product Foal of the Indium Thoroughbred Pedigree Model (i.e. the desired animal).

### Tellurium Embodiment

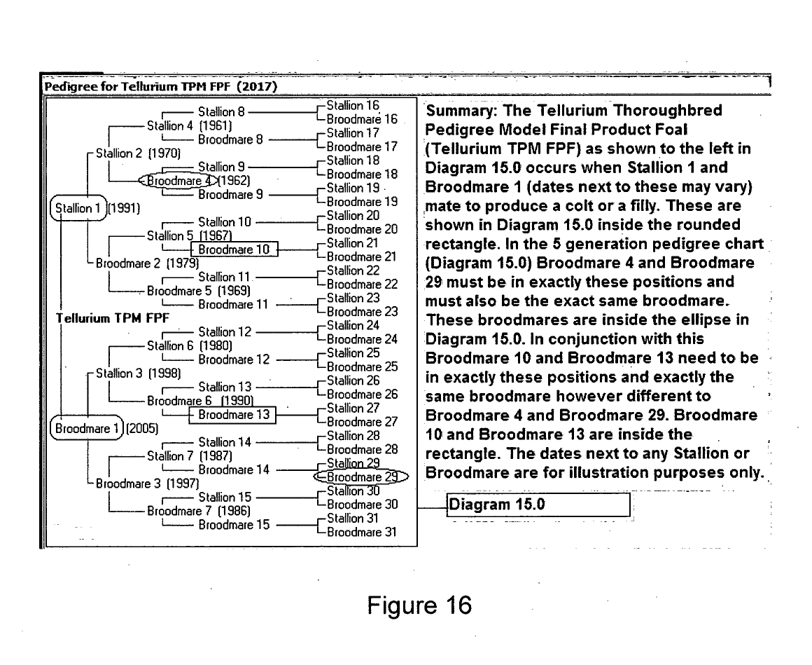

In the embodiment described herein, which may relate to horses both in Australia and Internationally, there is provided an example created by Global Bloodlines Pty Ltd (an Australian company which is also the applicant of this application) The example termed the “Tellurium Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 16, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The grand-dam (2^{nd} dam) (Broodmare 3 in the generic model) of the final product foal can be from any family in the studbook but firstly needs to be by a sire (Stallion 7 in the generic model) whose grand-dam (Broodmare 29 in the generic model) is exactly the same broodmare as the dam (Broodmare 4 in the generic model) of the Grand-sire (Stallion 2 in the generic model) of the Final Product Foal.
2. This grand-dam (2^{nd} dam) (Broodmare 3 in the generic model) in step 1 needs to be mated first of all with a Stallion (Stallion 3 in the generic model) that meets the specific criteria outlined in step 3 as well as Diagram 15.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) broodmare sire's (Stallion 5 in the generic model) dam (Broodmare 10 in the generic model) needs to be exactly the same broodmare as the Final Product Foal's Broodmare Sire's (Stallion 3 in the generic model) grand-dam (2^{nd} dam) (Broodmare 13 in the generic model)
4. The resulting foal from step 3 (either a filly or colt) is the Final Product Foal of the Tellurium Thoroughbred Pedigree Model (i.e. the desired animal).

### Diamond Embodiment

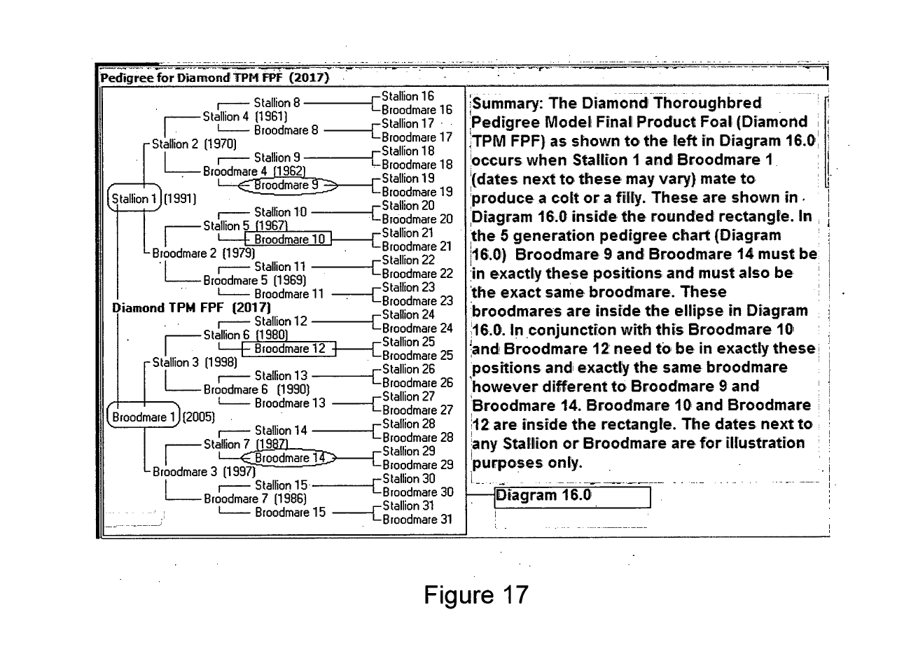

In the embodiment described herein, which may relate to horses both in Australia and Internationally, there is provided an example created by Global Bloodlines Pty Ltd (an Australian company which is also the applicant of this application) The example termed the “Diamond Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 17, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The grand-dam (2^{nd} dam) (Broodmare 3 in the generic model) of the final product foal can be from any family in the studbook but firstly needs to be by a sire (Stallion 7 in the generic model) whose dam (Broodmare 14 in the generic model) is exactly the same broodmare as the grand-dam (2^{nd} dam) (Broodmare 9 in the generic model) of the Grand-sire (Stallion 2 in the generic model) of the Final Product Foal.
2. This grand-dam (2^{nd} dam) (Broodmare 3 in the generic model) in step 1 needs to be mated first of all with a Stallion (Stallion 3 in the generic model) that meets the specific criteria outlined in step 3 as well as Diagram 16.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) broodmare sire's (Stallion 5 in the generic model) dam (Broodmare 10 in the generic model) needs to be exactly the same broodmare as the Final Product Foal's Broodmare Sire's (Stallion 3 in the generic model) sire's dam (Broodmare 12 in the generic model)
4 The resulting foal from step 3 (either a filly or colt) is the Final Product Foal of the Diamond Thoroughbred Pedigree Model (i.e. the desired animal).

### Bronze Embodiment

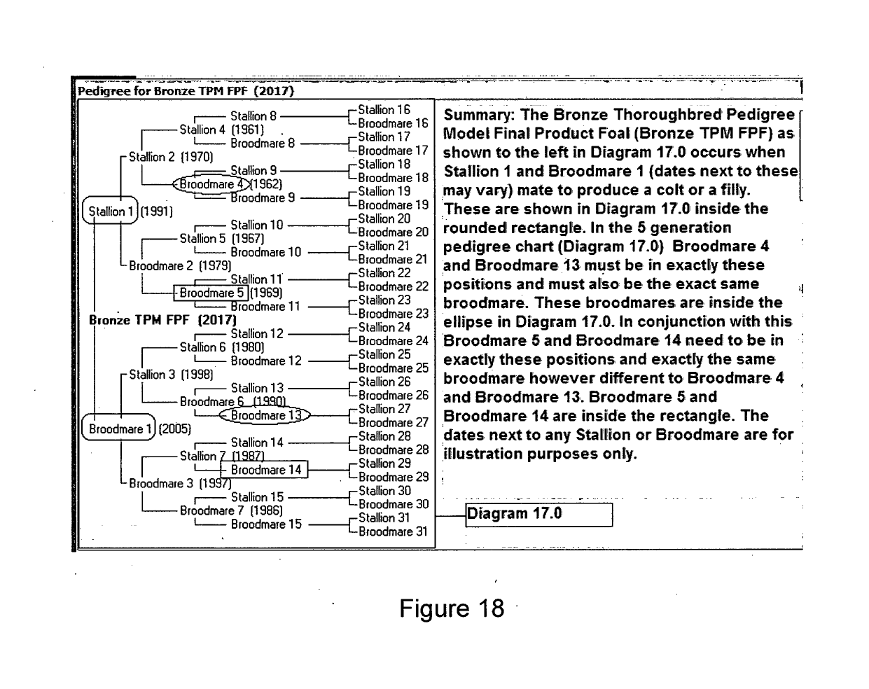

In the embodiment described herein, which may relate to horses both in Australia and Internationally, there is provided an example created by Global Bloodlines Pty Ltd (an Australian company which is also the applicant of this application) The example termed the “Bronze Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 18, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The grand-dam (2^{nd} dam) (Broodmare 3 in the generic model) of the final product foal can be from any family in the studbook but firstly needs to be by a sire (Stallion 7 in the generic model) whose dam (Broodmare 14 in the generic model) is exactly the same broodmare as the Final Product Foal's sire's grand-dam (2^{nd} dam) (Broodmare 5 in the generic model).
2. This grand-dam (2^{nd} dam) (Broodmare 3 in the generic model) in step 1 needs to be mated first of all with a Stallion (Stallion 3 in the generic model) that meets the specific criteria outlined in step 3 as well as Diagram 17.0. The resulting foal must be a filly for the model to be able to progress to the next step.
3. if a filly foal eventuates from step 2 then this filly (or mare once mature) needs to be mated with the Sire of the Final Product Foal (Stallion 1 in the generic model). This Sire's (Stallion 1 in the generic model) sire's (Stallion 2 in the generic model) dam (Broodmare 4 in the generic model) needs to be exactly the same broodmare as the Final Product Foal's Broodmare Sire's (Stallion 3 in the generic model) grand-dam (2^{nd} dam) (Broodmare 13 in the generic model)
4. The resulting foal from step 3 (either a filly or colt) is the Final Product Foal of the Bronze Thoroughbred Pedigree Model (i.e. the desired animal).

### Sapphire Embodiment

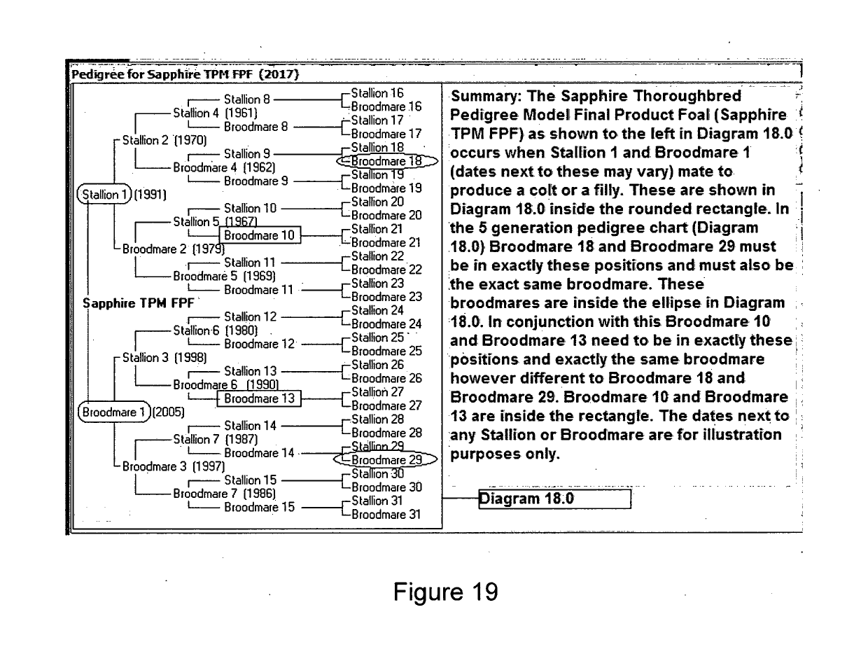

In the embodiment described herein, which may relate to horses both in Australia and Internationally, there is provided an example created by Global Bloodlines Pty Ltd (an Australian company which is also the applicant of this application). The example termed the “Sapphire Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 19, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The grand-dam (2^{nd} dam) (Broodmare 3 in the generic model) of the final product foal can be from any family in the studbook but firstly needs to be by a sire (Stallion 7 in the generic model) whose grand-dam (2^{st} dam) (Broodmare 29 in the generic model) is exactly the same-broodmare as the grand-sire's (Stallion 2 in the generic model) broodmare sire's (Stallion 9 in the generic model) dam (Broodmare 18 in the generic model) of the Final Product Foal.
2. This grand-dam (2^{nd} dam) (Broodmare 3 in the generic model) in step 1 needs to be mated first of all with a Stallion (Stallion 3 in the generic model) that meets the specific criteria outlined in step 3 as well as Diagram 18.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) broodmare sire's (Stallion 5 in the generic model) dam (Broodmare 10 in the generic model) needs to be exactly the same broodmare as the Final Product Foal's Broodmare Sire's (Stallion 3 in the generic model) grand-dam (2^{nd} dam) (Broodmare 13 in the generic model).
4. The resulting foal from step 3 (either a filly or colt) is the Final Product Foal of the Sapphire Thoroughbred Pedigree Model (i.e. the desired animal).

### Ruby Embodiment

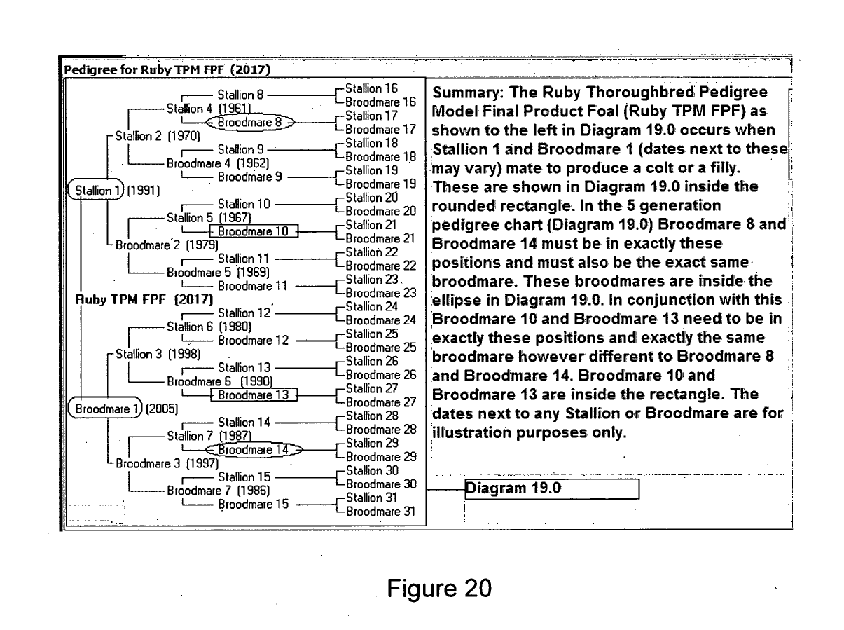

In the embodiment described herein, which may relate to horses both in Australia and Internationally, there is provided an example created by Global Bloodlines Pty Ltd (an Australian company which is also the applicant of this application) The example termed the “Ruby Thoroughbred Pedigree Model Final Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 20, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The grand-dam (2^{nd} dam) (Broodmare 3 in the generic model) of the final product foal can be from any family in the studbook but firstly needs to be by a sire (Stallion 7 in the generic model) whose dam (Broodmare 14 in the generic model) is exactly the same broodmare as the grand-sire's (Stallion 2 in the generic model) sire's (Stallion 4 in the generic model) dam (Broodmare 8 in the generic model) of the Final Product Foal.
2. This grand-dam (2^{nd} dam) (Broodmare 3 in the generic model) in step 1 needs to be mated first of all with a Stallion (Stallion 3 in the generic model) that meets the specific criteria outlined in step 3 as well as Diagram 19.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) broodmare sire's (Stallion 5 in the generic model) dam (Broodmare 10 in the generic model) needs to be exactly the same broodmare as the Final Product Foal's Broodmare Sire's (Stallion 3 in the generic model) grand-dam (2^{nd} dam) (Broodmare 13 in the generic model).
4. The resulting foal from step 3 (either a filly or colt) is the Final Product Foal of the Ruby Thoroughbred Pedigree Model the desired animal).

### Emerald Embodiment

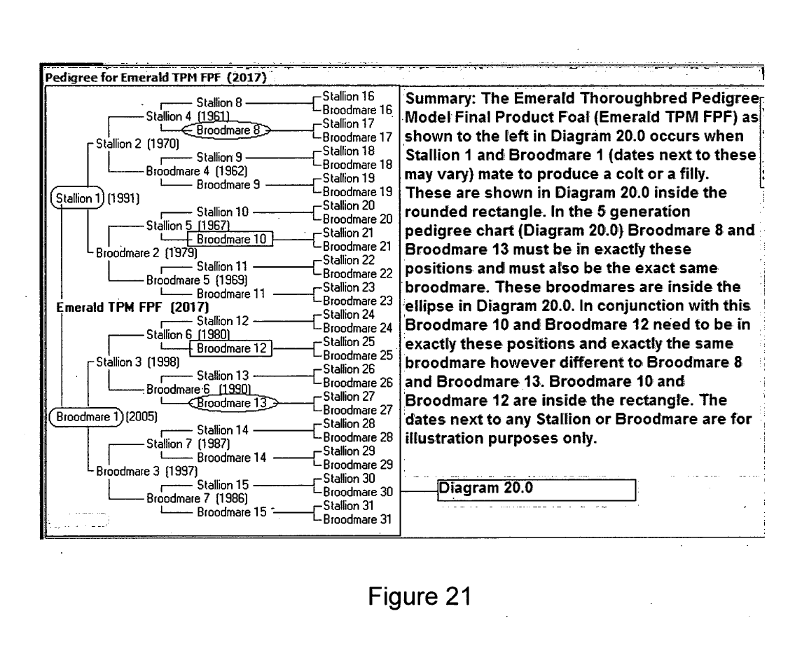

In the embodiment described herein, which may relate to horses both in Australia and Internationally, there is provided an example created by Global Bloodlines Pty Ltd (an Australian company which is the applicant of this application) The example termed the “Emerald Thoroughbred Pedigree Model Final. Product Foal”™. It is a methodology which is derived by applying the set of rules (i.e. an algorithm) to a particular bloodline. For the purpose of this example, particular horses are not identified, as the model relies on predefined patterns which apply irrespective of the specific horses in the family tree. Referring to FIG. 21, there is shown a Generic Model which lists a series of generations of horses (5 Generation pedigree chart), and the bloodlines (or blood ties) between each horse. It has been found that by applying the following algorithm, a suitable breeding pair (or suitable horse) may be identified:
1. The dam (1^{st} dam) (Broodmare 1 in the generic model) of the final product foal can be from any family in the studbook but firstly needs to be by a sire (Stallion 3 in the generic model) whose grand-dam (2^{nd} dam) (Broodmare 13 in the generic model) is exactly the same broodmare as the great grand-sire's (Stallion 2 in the generic model) sire's (Stallion 4 in the generic model) dam (Broodmare 8 in the generic model) of the Final Product Foal.
2. The grand-dam (2^{nd} dam) (Broodmare 3 in the generic model) needs to be mated first of all with the Final Product Foal's eventual Broodmare sire (Stallion 3 in the generic model) and this grand-dam (Broodmare 3 in the generic model) can be from any family in the stud book that meets the specific criteria outlined in step 3 as well as Diagram 20.0. The resulting foal must be a filly for the model to be able to progress to the next step.
3. If a filly foal eventuates from step 2 then this filly (or mare once mature) needs to be mated with the Sire of the Final Product Foal (Stallion 1 in the generic model). This Sire's (Stallion 1 in the generic model) broodmare sire's (Stallion 5 in the generic model) dam (Broodmare 10 in the generic model) needs to be exactly the same broodmare as the Final Product Foal's Broodmare Sire's (Stallion 3 in the generic model) sire's (Stallion 6 in the generic model) dam (Broodmare 12 in the generic model).
4. The resulting foal from step 3 (either a filly or colt) is the Final Product Foal of the Emerald Thoroughbred Pedigree Model (i.e. the desired animal).

### Alterations and Modifications to the Embodiments

In the preceding embodiment, reference has been made to a software application. It will be understood that the software application may be written in any appropriate computer language, and arranged to execute on any suitable computing hardware, in any configuration. The software application may be a stand alone software application arranged to operate on a personal computer, or a portable device such as laptop computer, or a wireless device, such as a tablet PC (personal computer) or a PDA (personal digital assistant).

The software application may alternatively be an application arranged to operate on a central server or servers, and may be accessible via a public or private network, such as the Internet.

Where the software application interfaces with another computing system or a database, the data may be communicated via any suitable communication network, including the Internet, a proprietary network (e.g. a private connection between different offices of an organisation), a wireless network, such as an 802.11 standard wireless network, or a telecommunications network (including but not limited to a telephone line, a GSM, 3G or CDMA mobile telephone network, or a microwave link).

It will be appreciated by persons skilled in the art that numerous variations and/or modifications may be made to the invention as shown in the specific embodiment without departing from the spirit or scope of the invention as broadly described. The present embodiments are, therefore, to be considered in all respects as illustrative and not restrictive.

### APPENDIX A

GB Pty Ltd's PTPM FPF—Global Bloodlines Pty Ltd's Platinum Thoroughbred Pedigree Model Final Product Foal.
Stallion 1—Sire of GB Pty Ltd's PTPM FPF
Broodmare 1—Dam of GB Pty Ltd's PTPM FPF
Stallion 2—Grand-sire of GB Pty Ltd's PTPM FPF
Broodmare 2—Dam of the sire of GB Pty Ltd's PTPM FPF
Stallion 3—Broodmare sire of GB Pty Ltd's PTPM FPF
Broodmare 3—Grand-dam (2^{nd} dam) of GB Pty Ltd's PTPM FPF
Stallion 4—Great grand-sire of GB Pty Ltd's PTPM FPF
Broodmare 4—Dam of the grand-sire of GB Pty Ltd's PTPM FPF
Stallion 5—Broodmare sire of the sire of GB Pty Ltd's PTPM FPF
Broodmare 5—Grand-dam (2^{nd} dam) of the sire of GB Pty Ltd's PTPM FPF
Stallion 6—Grand-sire of the dam of GB Pty Ltd's PTPM FPF

Broodmare 6—Dam of the broodmare sire of GB Pty Ltd's PTPM FPF

Stallion 7—Sire of the grand-dam (2^{nd} dam) of GB Pty Ltd's PTPM FPF
Broodmare 7—Great grand-dam (3^{rd} dam) of GB Pty Ltd's PTPM FPF
Stallion 8—Great great grand-sire of GB Pty Ltd's PTPM FPF
Broodmare 8—Dam of the great grand-sire of GB Pty Ltd's PTPM FPF
Stallion 9—Sire of the dam of the grand-sire of GB Pty Ltd's PTPM FPF
Broodmare 9—Grand-dam (2^{nd} dam) of the grand-sire of GB Pty Ltd's PTPM FPF
Stallion 10—Grand-sire of the dam of the sire of GB Pty Ltd's PTPM FPF
Broodmare 10—Dam of the broodmare sire of the sire of GB Pty Ltd's PTPM FPF
Stallion 11—Sire of the Grand-dam (2^{nd} dam) of the sire of GB Pty Ltd's PTPM FPF
Broodmare 11—Great grand-dam (3^{rd} dam) of the sire of GB Pty Ltd's PTPM FPF
Stallion 12—Great grand-sire of the dam of GB Pty Ltd's PTPM FPF
Broodmare 12—Dam of the grand-sire of the dam of GB Pty Ltd's PTPM FPF
Stallion 13—Sire of the dam of the broodmare sire of GB Pty Ltd's PTPM FPF
Broodmare 13—Grand-dam (2^{nd} dam) of the broodmare sire of GB Pty Ltd's PTPM FPF
Stallion 14—Grand-sire of the grand-dam of GB Pty Ltd's PTPM FPF
Broodmare 14—Dam of the sire of the grand-dam (2^{nd} dam) of GB Pty Ltd's PTPM FPF
Stallion 15—Sire of the great grand-dam (3^{rd} dam) of GB Pty Ltd's PTPM FPF
Broodmare 15—Great great grand-dam (4th dam) of GB Pty Ltd's PTPM FPF
Stallion 16—Great great great grand-sire of GB Pty Ltd's PTPM FPF
Broodmare 16—Dam of the great great grand-sire of GB Pty Ltd's PTPM FPF
Stallion 17—Sire of the dam of the great grand-sire of GB Pty Ltd's PTPM FPF
Broodmare 17—Grand-dam (2^{nd} dam) of the great grand-sire of GB Pty Ltd's PTPM FPF
Stallion 18—Grand-sire of the dam of the grand-sire of GB Pty Ltd's PTPM FPF
Broodmare 18—Dam of the sire of the dam of the grand-sire of GB Pty Ltd's PTPM FPF
Stallion 19—Sire of the grand-dam (2^{nd} dam) of the grand-sire of GB Pty Ltd's PTPM FPF
Broodmare 19—Great grand-dam (3^{rd} dam) of the grand-sire of GB Pty Ltd's PTPM FPF
Stallion 20—Great grand-sire of the dam of the sire of GB Pty Ltd's PTPM FPF
Broodmare 20—Dam of the grand-sire of the dam of the sire of GB Pty Ltd's PTPM FPF
Stallion 21—Sire of the dam of the broodmare sire of the sire of GB Pty Ltd's PTPM FPF
Broodmare 21—Grand-dam (2^{nd} dam) of the broodmare sire of the sire of GB Pty Ltd's PTPM FPF
Stallion 22—Grand-sire of the grand-dam (2^{nd} dam) of the sire of GB Pty Ltd's PTPM FPF
Broodmare 22—Dam of the sire of the grand-dam (2^{nd} dam) of the sire of GB Pty Ltd's PTPM FPF
Stallion 23—Sire of the great grand-dam (3^{rd} dam) of the sire of GB Pty Ltd's PTPM FPF
Broodmare 23—Great great grand-dam (4^{th} dam) of the sire of GB Pty Ltd's PTPM FPF
Stallion 24—Great great grand-sire of the dam of GB Pty Ltd's PTPM FPF
Broodmare 24—Dam of the great grand-sire of the dam of GB Pty Ltd's PTPM FPF
Stallion 25—Sire of the dam of grand-sire of the dam of GB Pty Ltd's PTPM FPF
Broodmare 25—Grand-dam (2^{nd} dam) of the grand-sire of the dam of GB Pty Ltd's PTPM FPF
Stallion 26—Grand-sire of the dam of the broodmare sire of GB Pty Ltd's PTPM FPF
Broodmare 26—Dam of the sire of the dam of the broodmare sire of GB Pty Ltd's PTPM FPF
Stallion 27—Sire of the grand-dam (2^{nd} dam) of the broodmare sire of GB Pty Ltd's PTPM FPF
Broodmare 27—Great grand-dam (3^{rd} dam) of the broodmare sire of GB Pty Ltd's PTPM FPF
Stallion 28—Great grand-sire of the grand-dam (2^{nd} dam) of GB Pty Ltd's PTPM FPF
Broodmare 28—Dam of the grand-sire of the grand-dam (2^{nd} dam) of GB Pty Ltd's PTPM FPF
Stallion 29—Sire of the dam of the sire of the grand-dam (2^{nd} dam) of GB Pty Ltd's PTPM FPF
Broodmare 29—Grand-dam (2^{nd} dam) of the sire of the grand-dam (2^{nd} dam) of GB Pty Ltd's PTPM FPF
Stallion 30—Grand-sire of the great grand-dam (3^{rd} dam) of GB Pty Ltd's PTPM FPF
Broodmare 30—Dam of the sire of the great grand-dam (3^{rd} dam) of GB Pty Ltd's PTPM FPF
Stallion 31—Sire of the great great grand-dam (4^{th} dam) of GB Pty Ltd's PTPM FPF
Broodmare 31—Great great great grand-dam (5^{th} dam) of GB Pty Ltd's PTPM FPF
NOTE: Appendix A describes the Platinum Model but depending on which model is used the description will change i.e. Stallion 1 for the Emerald Model would no doubt be Sire of GB Pty Ltd's Emerald TPM FPF. Also, a mare or stallion's position description may vary slightly to the notes in the specific embodiment i.e. Broodmare 12 in Appendix A is Dam of the grand-sire of the dam of the FPF; whereas in the embodiment it states “the FPF's broodmare sire's sire's dam”. It will be understood that both refer to exactly the same mare and the same position, but are expressed differently.

1. A method for selecting an animal with desirable characteristics, comprising the steps of:
receiving information regarding the parentage of the animal;
arranging the parentage information into an appropriate structure; and
utilizing an algorithm to identify a suitable animal based on the parentage of the animal.

2. The method in accordance with claim 1, wherein the appropriate structure is a tree structure.

3. The method in accordance with claim 1, wherein the algorithm is varied dependent on the geographical location of the animal.

4. The method in accordance with claim 1, wherein the algorithm comprises the further step of firstly identifying selected animals in the appropriate structure.

5. The method in accordance with claim 1, wherein each appropriate structure is held within a database.

6. The method in accordance with claim 4, wherein the animal is a horse.

7. The method in accordance with claim 1, wherein the algorithm includes locating a common ancestor in the appropriate structure.

8. The method in accordance with claim 7, wherein the common ancestor is a Broodmare.

9. The method in accordance with claim 7, wherein the algorithm includes the steps of identifying a grand dam (2nd dam) that is by a sire whose grand dam is the same broodmare as the dam of the Grand sire.

10. The method in accordance with claim 7, comprising the further step of determining whether the grand dam is mated with an identified Stallion.

11. The method in accordance with claim 8, comprising the further step of determining whether a filly foal eventuates from the mating of the grand dam and the stallion, and if so, requires the mating the filly with the Sire of the Final Product Foal, wherein the Sire's Grand dam is the same Broodmare as the Final Product Foal's Broodmare Sire's dam's Sire's dam.

12. The method in accordance with claim 1, wherein the method for selecting an animal with desirable characteristics is implemented by a processor.

13. The method in accordance with claim 12, wherein method may be implemented by a computing system.

14 . An apparatus for selecting an animal with desirable characteristics, comprising a processor and memory, arranged to receive information regarding the parentage of the animal, arranged to arrange the parentage information into an appropriate structure within the memory, and arranged to implement an algorithm to identify a suitable animal based on the parentage of the animal.

15. A computing program, comprising;
program instructions for receiving information regarding the parentage of the animal;
program instructions for arranging the parentage information into an appropriate structure; and
program instructions for utilizing an algorithm to identify a suitable animal based on the parentage of the animal.

16. The computer readable medium incorporating a computer program in accordance with claim 15.
